(19) United States
(12) Patent Application Publication
(10) Pub. No.: US 2021/0059102 A1
(43) Pub. Date: Mar. 4, 2021

(54) Planter Row Unit And Associated Systems And Methods

(71) Applicant: Ag Leader Technology, Ames, IA (US)

(72) Inventor: Mitchell Geistkemper, Slater, IA (US)

(21) Appl. No.: 17/011,737

(22) Filed: Sep. 3, 2020

Related U.S. Application Data
(60) Provisional application No. 62/895,018, filed on Sep. 3, 2019.

(51) Int. Cl. A01C 5/06

(52) U.S. Cl. CPC A01C 5/064; A01C 5/068

(57) ABSTRACT

The disclosure is related to agricultural row units. The row unit comprising a gauge wheel, a slicing sick, a seed knife, at least one closing wheel, and a press wheel. The gauge wheel and the press wheel may be mechanically linked via a linkage. The linkage may include an adjustable pivot point. In various implementations the slicing disc may be vertically adjustable.

### CROSS-REFERENCE TO RELATED APPLICATION(S)

This application claims the benefit under 35 U.S.C. § 119(e) to U.S. Provisional Application 62/895,018, filed Sep. 3, 2019, and entitled “Planter Row Unit and Associated Systems and Methods,” which is hereby incorporated herein by reference in its entirety for all purposes.

### TECHNICAL FIELD

The instant disclosure relates to planters, planter row units and related devices, systems, and methods. The disclosure further relates to various row units where downforce or pressure is generated by a seed knife as the seed knife is drawn through soil during planting.

### BACKGROUND

This disclosure relates to agricultural planters, particularly planter row units for use in planting operations including high speed planting of agricultural crops such as corn and soybeans.

Currently known planter row units use two flat opening discs set at an angle to spread the soil and create the seed trench. Because of their shape, these known opening discs have a natural tendency to lift out of the soil, resulting in the need for supplemental downforce to compensate for the lift to maintain proper planting depth.

There is a need in the art for planter row units with reduced complexity while remaining capable of ensuring proper planting depth and trench closure.

### BRIEF SUMMARY

Disclosed herein are various planter row units and associated devices, systems, and methods.

In Example 1, a row unit comprising a first gauge wheel and a second gauge wheel, a slicing disc constructed and arranged to create an opening in soil during planting, the slicing disc disposed between the first gauge wheel and the second gauge wheel, a seed knife disposed aft to the slicing disc, the seed knife constructed and arranged to form a seed trench in the opening, and a press wheel aft of the seed knife, wherein the press wheel and first gauge wheel and second gauge wheel are mechanically linked.

In Example 2, the row unit of claim 1, further comprising a seed tube aft of the seed knife, the seed tube constructed and arranged to deposit seed into the seed trench.

In Example 3, the row unit of claim 1, further comprising at least one closing disc disposed aft to the seed knife, the at least one closing disc constructed and arranged to close the seed trench after a seed has been deposited.

In Example 4, the row unit of claim 1, wherein the slicing disc is vertically adjustable on-the-go.

In Example 5, the row unit of claim 1, wherein the slicing disc and the seed knife are substantially aligned, such that the slicing disc and seed knife are located substantially along the centerline of the row unit.

In Example 6, the row unit of claim 1, wherein the seed knife is shaped to be drawn downwards during planting.

In Example 7, the row unit of claim 1, wherein the seed knife comprises flared edges constructed and arranged to loosen soil on the sides of the seed trench.

In Example 8, an agricultural planter comprising a plurality of row units, each row unit comprising a slicing disc, and a seed knife in line with the slicing disc, wherein the seed knife includes a sloped edge and a first wing and a second wing, the first wing and second wing disposed on opposite sides of the seed knife, and wherein the seed knife and opening disc are constructed and arranged to form a seed trench.

In Example 9, the planter of claim 8, further comprising a gauge wheel and a press wheel wherein the gauge wheel and press wheel are mechanically linked via a linkage.

In Example 10, the planter of claim 9, wherein the linkage is an elongate bar disposed on a pivot.

In Example 11, the planter of claim 10, wherein the pivot is adjustable such that the balance between the gauge wheel and press wheel are adjustable.

In Example 12, the planter of claim 8, further comprising a counterfill mechanism to maintain substantially equal weight of each row unit.

In Example 13, the planter of claim 8, wherein the agricultural planter does not include a supplemental downforce system.

In Example 14, the planter of claim 8, wherein the row units maintain a consistent planting depth over varied terrain.

In Example 15, a planter row unit comprising a single slicing disc, a seed knife disposed to the rear of the single slicing disc with respect to a forward travel direction of the planter row unit, a gauge wheel, and a press wheel mechanically linked to the gauge wheel via a linkage, wherein the linkage acts as a lever pivoting about a fulcrum disposed between the press wheel and the gauge wheel, and wherein the single slicing disc and the seed knife are constructed and arranged to open a seed trench.

In Example 16, the planter row unit of claim 15, wherein the linkage may be shifted on the fulcrum in the fore and aft directions.

In Example 17, the planter row unit of claim 15, wherein the fulcrum may be moved on the row unit in the fore and aft directions.

In Example 18, the planter row unit of claim 15, wherein the seed knife comprises a sloped edge.

In Example 19, the planter row unit of claim 15, wherein the seed knife includes one more wings shaped to engage soil on sides of a seed trench.

In Example 20, the planter row unit of claim 15, wherein the seed knife is substantially hook-shaped.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a side view of a planter row unit, according to one implementation.

FIG. 2 is a perspective view of the planter row unit, showing one half of the paired components, according to one implementation.

FIG. 3 is a side view of the planter row unit, showing one half of the paired components, according to one implementation.

FIG. 4 is a front view of the planter row unit, showing one half of the paired components, according to one implementation.

FIG. 5 is a top view of the planter row unit, showing one half of the paired components, according to one implementation.

FIG. 6 is a top view of the seed knife, according to one implementation.

### DETAILED DESCRIPTION

The various embodiments and implementations disclosed or contemplated herein relate to devices, methods, and systems for opening, closing, and planting within seed trenches by individual row units in agricultural planting applications. Exemplary implementations of the row unit disclosed and contemplated herein generate mechanical force, such as a downforce, via the arrangement of a seed knife that pulls the row unit towards the ground as the row unit traverses a field. That is, that shape of the seed knife and its substantially fixed orientation with respect to the row unit are configured to bring about a downforce on the row unit without the need for a supplemental downforce system such as a hydraulic system.

Many prior art row units require paired flat opening discs and a supplemental downforce system used together to open the seed trench consistently at the proper depth. In contrast, in certain of the implementations disclosed herein, the row unit has a single opening disc and a seed knife which, in combination, are able to cut a seed trench at the proper depth during planting and high-speed planting without the need for such a supplemental downforce system, thereby simplifying the row unit and reducing cost and the need for costly repairs.

Additionally, certain implementations of the disclosed row unit also optionally comprise a gauge wheel and press wheel mounted on a pivot configured to control the application of downward pressure on the soil in response to changing soil conditions. In these implementations, the row unit system works to maintain a consistent seed planting depth and proper trench closure without the need for supplemental downforce.

As such, it is appreciated that the row units disclosed and contemplated herein reduce and/or eliminate the need for costly and complicated supplemental downforce systems, while still providing control and consistency in planting seed depth. Additionally, certain of the row units disclosed herein provide for controllable compaction of the seed trench after planting.

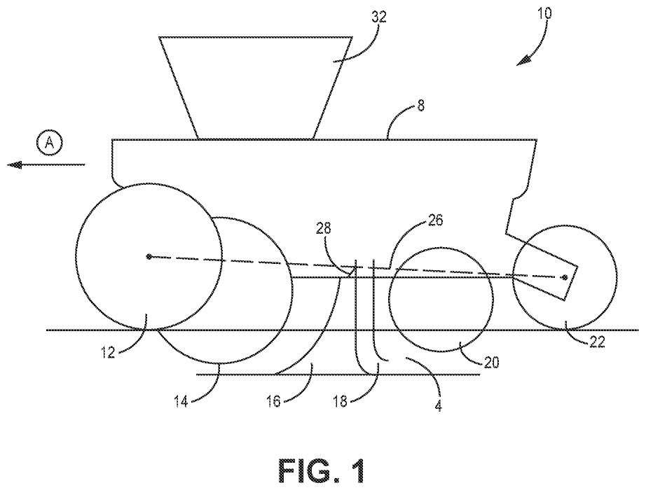

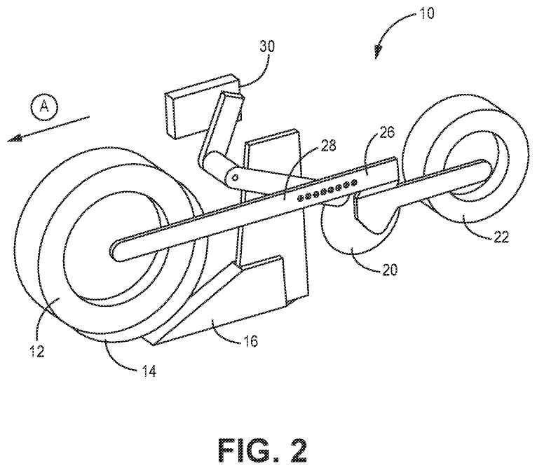

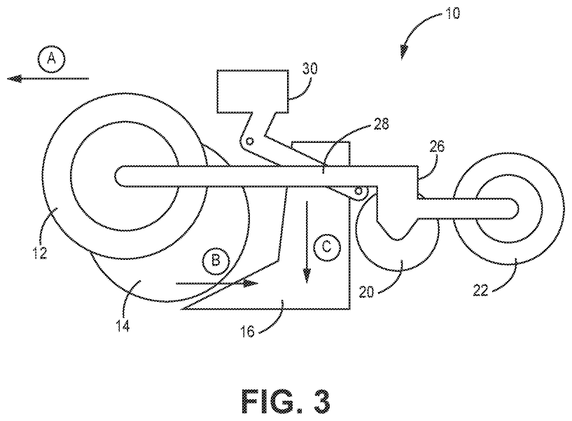

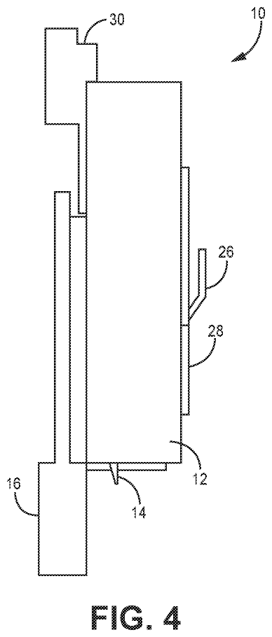

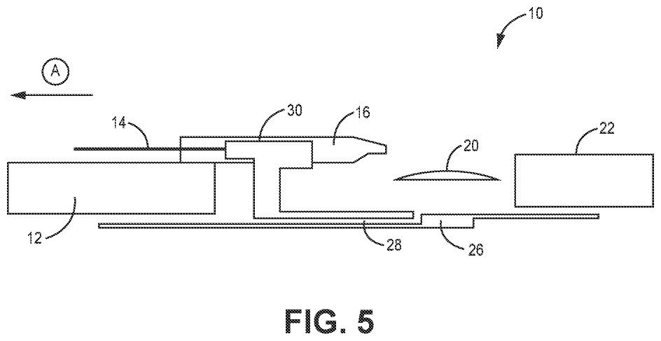

FIGS. 1-5 depict various views of an exemplary row unit 10, FIG. 1 showing a side view of the row unit 10, FIG. 2 showing a perspective view of the row unit 10, FIG. 3 showing a side view of the row unit 10, FIG. 4 showing a front view of the row unit 10, and FIG. 5 showing a top view of the row unit 10. It is understood that FIGS. 2-5 depict one half of the row unit 10, in that the central components are shown along with one side of the paired components, such as a single gauge wheel 12. That is, in these implementations, a gauge wheel 12 may be disposed on either side of the row unit 10 to establish proper planting depth, as in understood by those of skill in the art.

It is further understood from the forgoing disclosure that certain implementations will feature pairs of certain components (such as the gauge wheels) while other components (such as the slicing disc 14, seed knife 16 and/or press wheel 22 described below) may only appear on a single side of the row unit 10. It is further contemplated that components that appear on only one side of the row unit 10 will not all be present on the same side, that is the slicing disc 14 and seed knife 16 may be mounted to opposite sides of the row unit 10.

Certain of the disclosed row unit implementations can be used in conjunction with any of the devices, systems or methods taught or otherwise disclosed in U.S. application Ser. No. 16/121,065, filed Sep. 1, 2018, and entitled “Planter Down Pressure and Uplift Devices, Systems, and Associated Methods,” U.S. Pat. No. 10,743,460, filed Oct. 3, 2018, and entitled “Controlled Air Pulse Metering Apparatus for an Agricultural Planter and Related Systems and Methods,” U.S. application Ser. No. 16/272,590, filed Feb. 11, 2019, and entitled “Seed Spacing Device for an Agricultural Planter and Related Systems and Methods,” U.S. application Ser. No. 16/142,522, filed Sep. 26, 2018, and entitled “Planter Downforce and Uplift Monitoring and Control Feedback Devices, Systems and Associated Methods,” U.S. application Ser. No. 16/280,572, filed Feb. 20, 2019 and entitled “Apparatus, Systems and Methods for Applying Fluid,” U.S. application Ser. No. 16/371,815, filed Apr. 1, 2019, and entitled “Devices, Systems, and Methods for Seed Trench Protection,” U.S. application Ser. No. 16/523,343, filed Jul. 26, 2019, and entitled “Closing Wheel Downforce Adjustment Devices, Systems, and Methods,” U.S. application Ser. No. 16/670,692, filed Oct. 31, 2019, and entitled “Soil Sensing Control Devices, Systems, and Associated Methods,” U.S. application Ser. No. 16/684,877, filed Nov. 15, 2019, and entitled “On-The-Go Organic Matter Sensor and Associated Systems and Methods,” U.S. application Ser. No. 16/752,989, filed Jan. 27, 2020, and entitled “Dual Seed Meter and Related Systems and Methods,” U.S. application Ser. No. 16/891,812, filed Jun. 3, 2020, and entitled “Apparatus, Systems, and Methods for Row Cleaner Depth Adjustment On-The-Go,” U.S. application Ser. No. 16/997,361, filed Aug. 19, 2020, and entitled “Apparatus, Systems, and Methods for Steerable Toolbars,” and U.S. application Ser. No. 16/997,040, filed Aug. 19, 2020, and entitled “Adjustable Seed Meter and Related Systems and Methods,” each of which is incorporated herein.

Turning to the figures in greater detail, FIG. 1 depicts an overview of the row unit 10 having a frame 8 supporting various components, such as a gauge wheel 12 and a slicing disc 14. It is appreciated that in these implementations, the gauge wheel 12 can be any known gauge wheel or wheels 12 constructed and arranged to traverse the surface of the field. According to these implementations, the slicing disc 14 is disposed on the row unit 10 behind/between the gauge wheel(s) 12 relative to the direction of planting (shown at reference arrow A). It is understood that in these implementations, the slicing disc or discs 14 may be substantially flat discs or any other understood configuration. In various implementations, the slicing disc 14 is a metal disc but may be constructed from another suitable material as would be recognized by those of skill in the art.

As shown in FIG. 1, the row unit 10 according to these implementations further comprises a seed knife 16 disposed behind the slicing disc or discs 14. It is appreciated by those of skill in the art that the seed knife 16, according to these implementations, is constructed and arranged to cut through soil and create or form a seed trench 4. In various implementations, the seed knife 16 is contoured or otherwise shaped to engage with the sides of the seed trench 4 as the row unit 10 traverses a field. In various implementations, the seed knife 16 shaped to engage the soil in a such a manner that as the row unit 10 traverses a field the row unit 10 is pulled or otherwise urged downward toward the soil.

It is appreciated that this pull or other downward force brought about by the seed knife 16 engaging the soil and helps to ensure the row unit 10 opens the seed trench 4 at the proper planting depth. Said another way, the seed knife 16 according to these implementations is configured such as angled, shaped or otherwise fashioned to be driven into the soil during planting so as to create a downward pull, pressure, or force on the row unit 10, and thereby maintain proper planting depth. It is appreciated that in various implementations the seed knife 16 is therefore angled or pitched down from horizontal such that upon movement through the field in the direction of travel, that movement through the soil is translated into a downward “pull” force on the seed knife 16, as would be readily appreciated.

That is, in various implementations like that of FIG. 3, the shape, angle and/or contours of the seed knife 16 translate the force generated by traveling through the soil substantially horizontally (shown at reference arrow B) into vertical downforce (shown at reference arrow C) as a result of the shape, angle and/or contours of the seed knife 16, resulting in a downforce on the row unit 10 as it traverses a field. It is appreciated that as such, the downward translated force can, according to certain implementations, vary depending on the speed of the row unit 10 and/or vertical orientation of the slicing disc 14 as will be discussed further below.

Further, it is appreciated that the depth and/or pitch of the seed knife 16 can be adjusted in response to the various conditions such as speed, soil conditions or other information made available by the various sensors discussed in the incorporated references.

As such, the seed knife 16 according to the implementations of FIGS. 1-6 interacts with the soil to create a seed trench 4 and also to create downward force on the row unit 10. As the seed knife 16 is drawn through the soil, the soil and seed knife interact in such a way that the resistance from the soil drives the seed knife 16 further into the soil. This interaction and downward force on the seed knife 16 in turn creates a downward pull or force on the entire row unit 10, as would be appreciated.

Further, in these and other implementations, a seed tube 18, or other seed deposition mechanism, may be disposed behind the seed knife 16 to deposit a seed into the seed trench 4 after opening, as shown in FIG. 1. In further implementations, one or more closing discs 20 and/or a press wheel or wheels 22 are disposed behind the other components, as would be readily appreciated by those of skill in the art. In certain implementations, a single press wheel 22 is utilized on the row unit 10, while in alternate implementations a pair of press wheels 22 are utilized. Of course, other configurations of the various row unit 10 components are possible as would be appreciated by those of skill in the art. Further each row unit 10 need not include each and every component described herein.

As shown in FIGS. 1-5, in various implementations, the row unit 10 includes a one or more slicing discs 14 constructed and arranged to cut soil and foreign material in the field as the row unit 10 passes through the soil and over foreign material in advance of the seed knife 16 and seed tube 18. By cutting the foreign material with the slicing discs 14 the foreign material can thereby be pushed around the row unit 10 and/or seed knife 16 so as to allow passage of the seed knife 16 through a formed or partially formed trench 4.

Additionally, in various implementations, the slicing disc 14 is constructed and arranged to protect the seed knife 16 and row unit 10. In these and other implementations, each slicing disc 14 may engage foreign material and other objects before the seed knife 16 reaches that location in the field so as to allow for any foreign material to be cut or the row unit 10 to move around such foreign material, as would be understood. For example, the row unit 10 may encounter a rock in a field, in this example the slicing disc 14 will hit the rock such that the row unit 10 will lift and pass over the rock. As the row unit 10 lifts over a rock or other such object, the seed knife 16 will not strike the object and instead be lifted along with the row unit 10. As would be readily appreciated, a collision between a seed knife 16 and a rock or certain other foreign or hazardous materials may cause damage to the seed knife 16 or row unit 10, particularly during high-speed planting operations.

As also shown in FIGS. 1-5, in certain implementations, the row unit 10 includes only a single slicing disc 14. In these implementations, the single slicing disc 14 is constructed and arranged to perform many of the same functions as paired slicing discs 14. That is, a single slicing disc 14 can precut or score the soil, partially or wholly form a seed trench, and act as a shield to the seed knife 16 for encounter foreign or potentially hazardous materials.

In use according to certain implementations, the slicing disc 14 cuts the soil 2 immediately in front of the seed knife 16 and can be adjusted vertically via an adjustment mechanism 30, shown for example in FIGS. 2-5. In certain implementations, the slicing disc or discs 14 are vertically adjusted depending on various soil and/or planting conditions, as will be discussed further below. Further in certain implementations, the vertical adjustment of the slicing disc 14 may be dynamic and/or preset prior to planting.

In various implementations, the slicing disc 14 is constructed and arranged to precut or score the soil 2 in order to reduce the amount of force required to pull the seed knife 16 through the soil 2. That is, as noted above, the slicing disc 14 cuts through the soil 2 to precut or begin to open the seed trench 4, prior to passage of the seed knife 16 through the same soil 2.

Further, as depicted in FIGS. 1-5, and according to various implementations, a seed knife 16 is disposed on the row unit 10 behind the slicing disc 14 such as to widen the opening created by the slicing disc 14 thereby forming a seed trench 4. In certain implementations, the seed knife 16 is constructed and arranged to move soil to form a seed trench—that is to say the seed knife 16 is contoured or otherwise shaped in a manner such that when the seed knife 16 encounters soil the soil is urged to the sides of the seed knife 16 creating a trench 4.

In the various implementations of FIGS. 1-5, the seed knife 16 follows closely behind the slicing disc 14 while planting to ensure alignment between the precut/scored soil and the seed knife 16. For example, as a planter turns the seed knife 16 should closely follow the slicing disc 14 to create a clean trench 4. In various implementations, the seed knife 16 is constructed and arranged to create a seed trench 4 that remains open at least until a seed has been planted.

In some implementations, the seed knife 16 is substantially hook shaped. In various alternative implementations, the seed knife 16 may be sloped, similar to a cultivator blade or plow. In some implementations, the seed knife 16 includes a ½ to ¼ inch thick blade. The seed knife 16 may include a sweeping angle at the front of the seed knife 16, such that the seed knife 16 is drawn downward during planting contributing to overall downforce of the row unit 10. That is, the seed knife 16 may be shaped such that as the row unit 10 traverses a field during planting operations the seed knife 16 engaged with the soil in manner that the seed knife 16 and correspondingly the entire row unit 10 will experience a downward force. As noted above, the seed knife 16 may include various contours, angles, or other curves to contribute to its function.

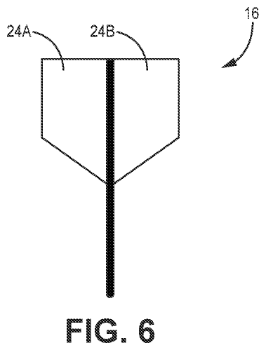

In these and other implementations, the seed knife 16 additionally includes wings 24A, 24B or horizontal lifters, as shown in FIG. 6. In wings 24A, 24B may be shaped as mere extensions of the central blade component(s) rather than as distinct components. Further, in certain implementation, the wings 24A, 24B are shaped and arranged to provide contact between the seed knife 4 and the sides of an open or partially open trench 4. In certain implementations, the wings 24A, 24B are constructed and arranged to loosen the soil around the seed trench 4. By loosening the soil around the seed trench 4 more favorable conditions for seed growth and emergence can be established, thereby increasing overall yield.

As noted above, and as shown throughout the implementations of FIGS. 1-5, the seed knife 16 in constructed and arranged such that it is pulled downward as it traverses soil 2 during planting. This downward force or pull contributes to the overall downforce experienced and/or created by the row unit 10 which is important in maintaining proper planting depth. Further, as noted above, the slicing disc 14 can be adjusted vertically up and down via any known adjustment mechanism 30, this vertical adjustment may then expose the seed knife 16 to either more or less soil 2. For example, the slicing disc 14 may be adjusted upward thereby exposing the seed knife 16 to more soil 2, this exposure to more soil 2 will cause increased downward pull on the row unit 10 due to increased resistance on the seed knife 16 which in turn may cause increased pressure on the closing discs 20 and overall increased down pressure. This type of increased down pressure may be desirable in sandy soil that requires more compaction after planting.

In another example, the slicing disc 14 may be adjusted downward thereby decreasing the amount of soil 2 the seed knife 16 is exposed to, the decreased exposure in turn decreases the downward pull on the seed knife 16 and therefore overall down pressure on the row unit 10 and optionally the closing discs 20. This decreased downforce on the row unit 10 and optionally the closing discs 20 may be desirable in clay soils that require less compaction for proper planting.

The implementations featuring a seed tube 18, like that of FIG. 1, can comprise any known seed tube 18 or seed planting mechanism as would be recognized by those of skill in the art. Various additional systems and devices may also be implemented near or around the seed tube 18 including fertilizer and chemical application systems as would be appreciated by those of skill in the art.

Turning back to FIGS. 1-5, in various implementations, one or more closing discs 20 are disposed on the row unit 10 behind the seed tube 18 to close the seed trench 4 after the seed is planted. In various implementations, the row unit 10 includes two closing discs 20 to cut down into the soil 2 and pull the soil 2 into the seed trench 4, as would be appreciated. Various other known closing mechanisms and devices may be used, as would be readily understood.

In these and other implementations, the row unit 10 includes an optional press wheel 22. A press wheel 22 may be constructed and arranged to apply pressure and/or push the soil 2 into the seed trench 4 to establish good soil-seed contact, as would be understood by those of skill in the art.

Shown for example in FIGS. 2-5, in various implementations, the gauge wheel(s) 12 and press wheel 22 are mechanically linked via a linkage 26. This linkage 26 allows for control of planting depth and trench closure. In certain implementations, the linkage 26 is a metal bar or other elongate member extending from the gauge wheel 12 to the press wheel 22. In various implementations, the linkage 26 rests on a pivot 28 or fulcrum 28. In certain implementations, the pivot 28 is located on the row unit 10 body 8.

In various implementations, the location pivot 28 between the gauge wheel(s) 12 and press wheel 22 may be adjustable, such that the balance between the gauge wheel 12 and press wheel 22 is articulated or otherwise incrementally adjusted, such as by a pin-and-openings or detent system, so as to adjust or otherwise articulate the pivot 28. In various implementations, the pivot 28 location may be adjusted prior to beginning planting operations or upon entering a field. In various alternative implementations, the pivot 28 is dynamically adjusted on-the-go either continuously or periodically.

It is understood that adjusting the pivot 28 affects the amount of downward pressure distributed between the gauge 12 and press wheels 22. That is, setting the pivot 28 equidistant between the wheels 12, 22, as shown in FIGS. 2-5, may evenly distribute the weight of the row unit 10 between both the gauge wheels 12 and press wheel 22. Setting the pivot 28 closer to the gauge wheel 12, shortening the pivot 28 to gauge wheel 12 segment of the linkage 26, has the effect of applying more downward pressure to the gauge wheels 12. Conversely setting the pivot 28 closer to the press wheels 22, shortening the pivot 28 to press wheel 22 segment of the linkage 26, applies proportionally more downward pressure on the press wheel 22.

In various implementations, the pivot 28 may be adjustable depending on soil and other planting conditions. As noted above and as would be appreciated, different soil conditions require varying amounts of force to properly close a seed trench 4. When soil conditions require more force to close the seed trench 4—such as with sandy soil—the pivot 28 may be moved forward (in the direction of the gauge wheel 12) such that more pressure is applied to the soil by the press wheel 22. In another example, when soil or other conditions require less force to close the seed trench—such with clay soil—the pivot 28 may be moved aft (in the direction of the press wheel 22) such that more pressure is applied by the gauge wheel 12 and less by the press wheel 22. In another example, the pivot 28 is located substantially near the seed tube 18, such that when soil conditions permit, the pivot 28 may be substantially intermediate of the gauge wheel 12 and press wheel 22 such that weight and/or pressure is evenly distributed between the gauge wheel 12 and the press wheel 22.

In certain of the implementations described herein, planting depth may be is controlled by two points of soil contact—the gauge wheel 12 and press wheel 22, shown in FIGS. 1-5. When there is only one point of contact—such as with known planter row units—the gauge wheel 12 alone controls planting depth, and when the row unit 10 encounters a dirt clod the row unit 10 may jolt or move upward away from the soil. This sudden upward movement of the row unit 10 may shake seeds from the seed disc which may cause skips and/or shallow placement of the seed.

Further in various implementations, having two points of soil contact allows for a steadier flight for the row unit 10 through rough soil. Because the gauge wheel 12 and press wheel 22 are linked via the linkage 26 and pivot 28 the row unit 10 will not jolt as easily or as much when traversing rough terrain thereby reducing the likeliness of shaking seeds from the seed disc, skipping a plant, and/or placing the seed at an incorrect depth.

In some implementations, the row unit 10 includes a seed box and/or insecticide hopper, shown for example in FIG. 1. In these and other implementations, the weight of the row unit 10 may change dramatically across planting operations as the seed box and/or insecticide hopper deposit their respective contents on the field. This change in weight may correspond to change in downforce on the row unit 10 overall. In some implementations, a counterfill mechanism may be implemented to counteract the change in weight. That is, the row unit 10 may include a pathway to take on extra weight, such as from the tractor, to replace the lost weight from deposited materials. In certain implementations, the counterfill mechanism may include pumping water, additional seed or chemical or other appreciated material to the row unit 10 to replace lost material weight. In these and other implementations, the row unit 10 is constructed and arranged to have a substantially constant overall weight throughout planting operations.

In various alternative implementations, a seed and insecticide can be delivered to each individual row unit 10 via one or more connections, such that the seed and/or insecticide are not stored on each individual row unit 10 but rather on the tractor, toolbar, or other location as would be appreciated by those of skill in the art. In these implementations, the row unit 10 may maintain a substantially constant weight throughout planting operations without a need for a counterfill mechanism.

Although the present disclosure has been described with references to various embodiments, persons skilled in the art will recognized that changes may be made in form and detail without departing from the spirit and scope of this disclosure.

What is claimed is:

1. A row unit comprising:
(a) a first gauge wheel and a second gauge wheel;
(b) a slicing disc constructed and arranged to create an opening in soil during planting, the slicing disc disposed between the first gauge wheel and the second gauge wheel;
(c) a seed knife disposed aft to the slicing disc, the seed knife constructed and arranged to form a seed trench in the opening; and
(d) a press wheel aft of the seed knife, wherein the press wheel and first gauge wheel and second gauge wheel are mechanically linked.

2. The row unit of claim 1, further comprising a seed tube aft of the seed knife, the seed tube constructed and arranged to deposit seed into the seed trench.

3. The row unit of claim 1, further comprising at least one closing disc disposed aft to the seed knife, the at least one closing disc constructed and arranged to close the seed trench after a seed has been deposited.

4. The row unit of claim 1, wherein the slicing disc is vertically adjustable on-the-go.

5. The row unit of claim 1, wherein the slicing disc and the seed knife are substantially aligned, such that the slicing disc and seed knife are located substantially along the centerline of the row unit.

6. The row unit of claim 1, wherein the seed knife is shaped to be drawn downwards during planting.

7. The row unit of claim 1, wherein the seed knife comprises flared edges constructed and arranged to loosen soil on the sides of the seed trench.

8. An agricultural planter comprising a plurality of row units, each row unit comprising:
(a) a slicing disc; and
(b) a seed knife in line with the slicing disc,
wherein the seed knife includes a sloped edge and a first wing and a second wing, the first wing and second wing disposed on opposite sides of the seed knife, and wherein the seed knife and opening disc are constructed and arranged to form a seed trench.

9. The planter of claim 8, further comprising a gauge wheel and a press wheel wherein the gauge wheel and press wheel are mechanically linked via a linkage.

10. The planter of claim 9, wherein the linkage is an elongate bar disposed on a pivot.

11. The planter of claim 10, wherein the pivot is adjustable such that the balance between the gauge wheel and press wheel are adjustable.

12. The planter of claim 8, further comprising a counterfill mechanism to maintain substantially equal weight of each row unit.

13. The planter of claim 8, wherein the agricultural planter does not include a supplemental downforce system.

14. The planter of claim 8, wherein the row units maintain a consistent planting depth over varied terrain.

15. A planter row unit comprising:
(a) a single slicing disc;
(b) a seed knife disposed to the rear of the single slicing disc with respect to a forward travel direction of the planter row unit;
(c) a gauge wheel; and
(d) a press wheel mechanically linked to the gauge wheel via a linkage,
wherein the linkage acts as a lever pivoting about a fulcrum disposed between the press wheel and the gauge wheel, and wherein the single slicing disc and the seed knife are constructed and arranged to open a seed trench.

16. The planter row unit of claim 15, wherein the linkage may be shifted on the fulcrum in the fore and aft directions.

17. The planter row unit of claim 15, wherein the fulcrum may be moved on the row unit in the fore and aft directions.

18. The planter row unit of claim 15, wherein the seed knife comprises a sloped edge.

19. The planter row unit of claim 15, wherein the seed knife includes one more wings shaped to engage soil on sides of a seed trench.

20. The planter row unit of claim 15, wherein the seed knife is substantially hook-shaped.
